(19) United States
(12) Patent Application Publication
(10) Pub. No.: US 2009/0182572 A1
(43) Pub. Date: Jul. 16, 2009

(54) SYSTEM FOR DETERMINING EQUIPMENT REPOSITIONING PLANS

(76) Inventor: Sebastian P. Mendoza Garrido, San Miguelito (PA)

Correspondence Address: Vierra Magen Marcus & DeNiro LLP, 575 Market Street, Suite 2500, San Francisco, CA, 94105, US

(21) Appl. No.: 12/352,929

(22) Filed: Jan. 13, 2009

Related U.S. Application Data
(60) Provisional application No. 61/020,853, filed on Jan. 14, 2008.

(51) Int. Cl. G06Q 10/00

(52) U.S. Cl. 705/1

(57) ABSTRACT

A system and method are disclosed for maximizing equipment transport and vehicle space utilization by reducing the amount of equipment repositioning plans and reducing vehicles rotation between a plurality of shipping companies. The present system receives equipment repositioning plans or equipment use forecast from each shipping company. The system then defines outflow and inflow plans, matches outflow plans from the different shipping companies with inflow plans from other shipping companies, and proposes corrections or cancellations of plans where matches are found before execution.

### CROSS REFERENCE TO RELATED APPLICATION

The present application claims priority to U.S. Provisional Patent Application No. 61/020,853, to Sebastian P. Mendoza Garrido, entitled, “SYSTEM, METHOD AND COMPUTER PROGRAM PRODUCTS FOR VALIDATING EQUIPMENT REPOSITIONING PLANS,” filed Jan. 14, 2008. This provisional patent application is incorporated by reference herein in its entirety.

### BACKGROUND

1. Field

The present invention relates to a system for validating equipment repositioning.

2. Description of the Related Art

Shipping companies use equipment such as containers to transport their customer cargoes from an export-dominant location to an import-dominant location, where the cargo is then offloaded from the containers. In an ideal situation, the amount of shipping equipment being imported into a given location should equal the amount of shipping equipment being exported from that given location within a particular time period. This would ideally be true for all shipping locations to balance equipment requirements and ensure maximum efficiency in the transport of shipping equipment and resources.

However, in order to reach this ideal, shipping equipment has to be ready at the right place (location) and at the right time because the vessels, trains and other transport vehicles used to move shipping equipment work in liner term schedules; meaning transport vehicles depart on a set schedule and do not wait until equipment is offloaded and/or available. Given this limitation, it is generally true that transport vehicles depart from import-dominant locations with open space. Not only is this inefficient, but it also causes service failure at the export-dominant locations because of the lack of equipment at the export-dominant locations. Consequently, offloaded equipment accumulates in the import-dominant location because it does not get offloaded or otherwise become available until after the transport vehicle has departed from the import-dominant location.

Since the unused space on those transport vehicles and shipping equipment is paid whether it is used or not, it affects liner shipping companies' operating costs.

As mentioned, the lack of offloaded equipment ready to be moved back to an export-dominant location on a scheduled transport vehicle results in unnecessary operating costs due to equipment shortages in the export-dominant location and unused space on the transport vehicles. The shipper also faces unnecessary operating costs due to the accumulation in an import-dominant location of equipment that was offloaded only after the transport vehicle departed. There are three possible solutions to avoid at least some of these problems: (1) leave equipment to get accumulated at the import-dominant location and send an extra (non-liner term) transport vehicle to load the accumulated equipment; (2) reduce the frequency of transport vehicle rotation, in order to provide extra time to get shipping equipment ready and maximize vehicle capacity; and (3) use offloaded and/or available equipment from another shipping company under a business agreement or alliance to fulfill vehicle space departing from a import dominant location to an export location.

Option 1 incurs extra costs due to the extra non-liner transport vehicles required to balance the equipment that was already paid for by the shipping company. Options 2 or 3 similarly have been shown to have disadvantages. A still further solution that has been tried is a combination of options 2 and 3. In general, most liner shipping companies make an effort to select calling locations, in particular taking into account effective plans of an efficient repositioning of equipment in use based on a prediction of when and where imbalance in equipment quantities will occur. Shipping companies have also recently entered into container interchange agreements; two liner shipping companies agree to utilize each other's containers. The problem with this solution is that liner shipping companies facing problems to maximize vehicles and equipment utilization often do not have timely information regarding when and where offloaded equipment outflow and inflow plans will occur in order to efficiently match equipment availability with best vehicle space utilization. Accordingly, there is a need for a system and method for receiving timely information regarding availability, time and location of equipment repositioning plans (outflow and inflow), from import and export dominant locations in order to enable shipping companies to operate more efficiently and cost-effectively. Embodiments of the present invention satisfy this need.

### SUMMARY

Embodiments of the present invention maximize the equipment and consequently vehicle space utilization by reducing the amount of equipment repositioning plans and reducing vehicles rotation between a plurality of shipping companies. Users of present invention receive equipment repositioning plans and/or equipment use forecasts from each shipping company. The present system then defines outflow and inflow plans, matches outflow plans from the different shipping companies with inflow plans from other shipping companies, and proposes corrections or cancellations of plans where matches are found before execution.

A data processing system comprises a user interface that is accessible by each shipping company via respective client devices, a database for storing the plans received from each shipping company, a match maker engine (software or hardware in combination with software) that matches outflow with inflow plans and a transaction management engine that enables shipping companies to correct/confirm or cancel/refuse those outflow and inflow plans and send instruction messages to interested parties for execution. Each shipping company uses its client device to report its equipment repositioning plans or equipment use forecast of selected equipment for a next planning horizon.

In one operational embodiment, after collecting the list of required equipment repositioning plans or equipment use forecast plans from each shipping company, the match maker engine automatically splits the plan in two plans (outflow and inflow), thereby creating two plans, and automatically matches outflow with inflow equipment positioning plans of different shipping companies. The transaction management engine then automatically recommends corrections or cancellations to those plans and automatically creates and sends instruction messages to the interested parties maximizing vehicle space and equipment utilization. In one embodiment, the matching process comprises a three-way match criterion. Preferably, the system software will provide automatic management services to track the confirmed proposals and to manage associated financial aspects, such as billing (creating and sending bills). The system also preferably comprises a real-time management system to automatically perform up-to-the-second searches for alternate equipment with real-time reporting of the results of the searches and recommendations based on the searches.

The system and method of the present invention can be used to create and report equipment repositioning information and provide vehicle maximization analysis/service to various shipping companies around the world. This service is provided by a neutral third party. Preferably, the shipping companies that desire to use the service will pay the neutral third party for this service.

Service fees may be generated for one or a combination of the several components described herein. For example, there may be a fixed fee to join the service, i.e., a sign-up fee. There could also be periodic fees (monthly, annual fee, etc.) to use the service, and/or transaction fee that is applicable when a outflow or inflow plan correction or cancellation is recommended to at least two shipping companies, and/or a fee charged whenever a proposed correction to the equipment repositioning plan is confirmed by the two system users or shipping companies. Fees (flat or per transaction) may depend on customer volume and other criteria (previous volume, frequency of use of services, fidelity, etc.), urgency of the match (with services such as regular, express, urgent, etc.), and other suitable criteria.

The present invention can be accomplished using hardware, software, or a combination of both hardware and software. The software used for the present invention is stored on one or more processor readable storage devices including hard disk drives, CD-ROMs, DVDs, optical disks, floppy disks, flash memory, tape drives, RAM, ROM or other suitable storage devices. The software is used to program one or more processors to perform the methods described herein. In alternative embodiments, some or all of the software can be replaced by dedicated hardware including custom integrated circuits, gate arrays, FPGAs, PLDs, and special purpose computers.

One embodiment includes a machine implemented method for maximizing equipment and vehicle utilization by reducing the amount of equipment positioning plans among a plurality of shipping companies. The method includes receiving a report of equipment repositioning plans or equipment use forecasts from each shipping company, automatically duplicating equipment repositioning plan by creating a second plan, automatically assigning the departure location to the original plan and the destination location to the second/duplicated plan as their execution location, automatically matching equipment pairs of reported equipment repositioning plans from a first shipping company and created duplicate plans reported at the same specific location from a second shipping company from the received report of equipment positioning plan and duplicate plans, and automatically proposing the selected equipment pair to the first and second shipping companies for a cancellation or correction transaction of matched equipment positioning plans pair between them. Wherein the step of proposing includes creating and reporting a proposal to the first and second shipping companies.

One embodiment includes one or more processor readable storage devices having processor readable code embodied on said processor readable storage devices, said processor readable code for programming one or more processors to perform a method for maximizing equipment and vehicle utilization by reducing the amount of equipment positioning plans among a plurality of shipping companies. The method includes receiving a report of equipment repositioning plans or equipment use forecast from each shipping company, duplicating equipment repositioning plan creating a second plan assigning the departure location to the original plan and the destination location to the second/duplicated plan as their execution location, matching equipment pairs of reported equipment repositioning plans from a first shipping company and created duplicate plans reported at the same specific location from a second shipping company from the received report of equipment positioning plan and duplicate plans, and proposing the selected equipment pair to the first and second shipping companies for a cancellation or correction transaction of matched equipment positioning plans pair between them.

One embodiment includes a communication interface such as a network card or modem, one or more storage devices and one or more processors in communication with said one or more storage devices and said communication interface. The one or more processors receive a report of equipment repositioning plans or equipment use forecast from each shipping company, duplicate equipment repositioning plan creating a second plan assigning the departure location to the original plan and the destination location to the second/duplicated plan as their execution location, match equipment pairs of reported equipment repositioning plans from a first shipping company and created duplicate plans reported at the same specific location from a second shipping company from the received report of equipment positioning plan and duplicate plans, and propose the selected equipment pair to the first and second shipping companies for a cancellation or correction transaction of matched equipment positioning plans pair between them.

### BRIEF DESCRIPTION OF THE DRAWINGS

FIG. 1 is a block diagram of one embodiment of a system of the present invention.

FIG. 2 is a flow diagram illustrating the operation of the system of FIG. 1.

FIGS. 3A and 3B illustrate an example of the operation of an embodiment of the present invention.

FIG. 4 is a block diagram of a computing system for implementing embodiments of the present invention.

### DETAILED DESCRIPTION

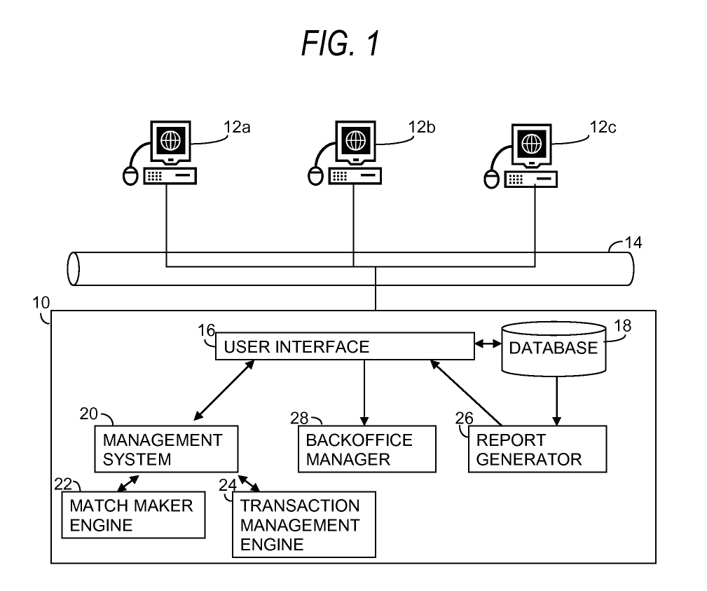

Referring to the drawings, wherein like numerals represent like elements throughout, FIG. 1 is a block diagram of a system for reducing the amount of equipment repositioning plans and therefore maximizing transport vehicle space utilization between a plurality of shipping companies, in accordance with one embodiment of the present invention. As used herein, a shipping company's equipment repositioning plan represents the shipper's plan to move shipping equipment between two or more locations up to a given planning horizon. As use herein, the term “shipping company” includes maritime companies (e.g. freight forwarders, shipping lines, airlines, other cargo companies, etc) as well as independent ground transporters that provide transportation services to the shipping companies (e.g. trucking and rail companies).

As shown in FIG. 1, in one embodiment, the system has a client-server architecture. Each shipping company has a client device, e.g., client devices 12a, 12b, 12c, etc., that communicate with system server 10 via network 14. Each client device may 12a, 12b, 12c may comprise a personal computer, workstation, terminal, personal digital assistant (PDA) or other device capable of communicating over the network 14. The network 14 may compromise a local area network (LAN), a wide area network (WAN), the Internet, an intranet, dedicated data lines, a cellular, wireless, microwave, satellite or other wireless network, or any other suitable type of communication network. In embodiments, the server 10 resides at a third party administration building and is maintained by the system administrator employed by the third party company. However, it is contemplated that server 10 reside at a shipping company making use of the present invention in alternative embodiments.

According to the present invention, each client uses client device, (e.g., 12a, 12b, 12c) to report to the server 10, on periodic basis, its equipment repositioning plans or equipment use forecast of selected equipment for the next planning horizon. In embodiments, a planning horizon includes high level commercial demand figures provided by sales department. It reflects the equipment needs by location. The planning horizon may be considered as being separate from, or part of, the equipment repositioning plan in different embodiments of the present invention. As used herein the term “outflow plan” means a plan created to reposition equipment from a departure location and the term “inflow plan” means the duplicated plan created by the match maker engine to reposition equipment to a destination location where the repositioning plan will end. Also, as used herein the term “planning horizon” means a pre-determined future time period for which the shipping companies report their equipment repositioning plans. For example, a planning horizon may compromise a selected number of seconds, minutes, hours, days, weeks, or months. In one embodiment, the shipping companies report their equipment repositioning plans on a second basis, for the next second period (i.e. the planning horizon is the next second period).

After collecting the list of equipment repositioning plans from each shipping company, the server 10 duplicates them creating a second plan for each equipment repositioning plan, the first plan becomes the outflow plan and the second plan becomes the inflow plan, and matches outflow with inflow equipment repositioning plans among the various shipping companies. The sever 10 will then recommend corrections or cancellations to those plans, maximizing vehicle and equipment utilization, and will send instruction messages to the interested parties. The server 10 will provide equipment management service to track equipment under confirmed or corrected equipment positioning plans and its associated financial aspects, such as billing. The server 10 also preferably will be equipped with a real-time management system to process up-to-the-second searches for matching equipment positioning plans with real-time reporting capabilities.

Preferably, the system and method of the present invention can be used to provide an equipment repositioning information and vehicle maximization service to various shipping companies around the world. This service may be provided by a neutral third party. Preferably, the shipping companies that desire to use the service will pay the neutral third party for this service. Service fees may consist of several components. For example, the first part may be a fixed fee to join the service, i.e., a sign-up fee. The second component may be a monthly or annual fee to use the service, the third component may be a per transaction fee that is applicable when an outflow or inflow plan correction or cancellation is recommended or proposed to two system users, and the fourth component may be a fee charged whenever a proposed correction to the equipment repositioning plan is confirmed by the two system users. The per transaction fees may be for either be a fixed dollar (or other currency) amount per transaction (that could depend on the customer volume, fidelity, and other characteristics), or for certain percentage of the transaction, or some other suitable combination.

Still referring to FIG. 1, in one embodiment, the server 10 comprises a user interface 16 accessible by the respective client devices 12a, 12b, 12c of each shipping company via the network 14, a database 18 for storing reported outflow and inflow plans created from the received plans from each shipping company, a match maker engine 22 for matching an outflow equipment positioning plan from one shipping company with a inflow equipment positioning plan of another shipping company and for reporting proposed equipment positioning plan cancellation or correction to the interested shipping companies. The server 10 further includes a transaction management engine 24 to support equipment management services, and a report generator 26 for developing canned and customized reports to capture information on equipment positioning plan correction or cancellation execution. The server 10 may comprises a conventional personal computer or computer workstation with sufficient memory and processing capability to handle the processing functionality of the various system components. Alternatively, the server 10 can be implemented in a distributed architecture comprising a plurality of personal computers or computer workstation, wherein different functional components of the system operates on different computers in a distributed manner.

The user interface 16 provides a means for shipping companies to report their equipment positioning plans for each planning horizon to the server 10, and a means for the server 10 to report back to the shipping companies recommended cancellation or correction to an equipment positioning plan to improve equipment and vehicle utilization. A shipping company improves equipment utilization by using other shipping company equipment available in the inflow location (destination location), so the shipper's repositioning plan is not required. On the other side, a shipping company improves vehicle utilization by filling its transport vehicle with equipment of the other shipping company available in the outflow location (departure location). The backoffice manager interface 28 is used by the server administrator (e.g., the third party company offering the service) to input and manipulate the database 18, to view input and output data, and to override output results.

In embodiments, the user interface 16 and the backoffice manager 28 use known web-based technology (e.g. Hyper-Text Markup Language (HTML), Common Gateway Interface (CGI) scripting, Java, or the like) to enable the client devices 12a, 12b, 12c to interact with the server 10 using commercially available Web browsers, such as Microsoft Internet Explorer, Nestcape Navigator, or the like. Alternatively, the user interface 16 may operate in conjunction with a special purpose client program (not shown) that runs on each client device 12a, 12b, 12c to provide the necessary client-server interaction. In still other embodiments, shipping companies can report their equipment positioning plans or equipment use forecast via electronic mail, voice mail, facsimile, or postal mail, in which case manual entry of the information at the server 10 may be required. Also shipping companies can use electronic data interchange (EDI), eXtensible Markup Language (XML) and any other automatic transfer data component to keep database 18 automatically up-to-date.

In embodiments, the user interface 16 presents a form-based entry mechanism to enable each shipping company to report the following information for a given type of equipment for the next planning horizon:
shipping company Name and/or Identification (ID); and
Equipment Repositioning Plan, including:
   i. Departure Location (equal to Outflow location name)
   ii. Destination Location (equal to Inflow location name)
   iii. Equipment Size (20′, 40′, 45′, etc.)
   iv. Equipment type (chassis type, container type, etc.)
   v. Equipment Sub-type (Reefer, Dry, Flat, etc.)
   vi. Quantity of equipment to be moved
   vii. Execution time (e.g., departure time specifying year, month, day, hour, minute)
   viii. Vehicle name and/or identification (ID).

The input can be repeated for each location for which a given shipping company has equipment repositioning plan. The server 10 stores the above information reported by each shipping company in the database 18.

The database 18 stores both static data and dynamic data. Static data includes data sets that do not change frequently and accordingly due not require heavy maintenance. Dynamic data are data sets that change more frequently and accordingly require more maintenance. The database can be implemented using commercially available database software running on the server 10, such as, for example, the Oracle family of database software available from Oracle Corporation.

Static data on the database 18 includes the following types of data: (i) movable assets data, (ii) shipping company-related data, and (iii) customer priority level data. Movable assets data comprises information concerning the attributes of the various types of shipping equipment for which the shipping companies may report equipment repositioning plans. Equipment attributes include, for example, industry name, brand, aliases, capacity, geometrical specifications (if applicable), mechanical specifications (if applicable), electrical specification (if applicable). Shipping company-related data comprises, for example, shipping company name address and contact information, alliance, affiliation, etc. The shipping company-related data may also include an identification of desirable shipping companies, i.e., other shipping companies the shipping company prefers to work with. Customer priority level data specifies the actual priority given to a shipping company based on defined criteria by the system administrator and may be considered by the match maker engine in determining the most preferable order in time/date to send proposal of correction/cancellation to a client equipment repositioning plan.

Dynamic data stored in the data base includes: (i) the equipment positioning plans information reported by each shipping company for each planning horizon otherwise a equipment use forecast, (ii) the information used by the transaction management engine 24 to track the amount of equipment repositioning plans under a confirmed proposal, including, for example, the equipment quantity, identification of the involved parties, fees, execution status and update information, etc., and (iii) information associated with the matching process as described more fully below.

The match maker engine 22 is responsible for identifying an optimum matching between reported equipment repositioning plans over a given planning horizon. For purposes of describing one embodiment of the match maker engine the following terms have the following meanings:

“Exact Repositioning-plan Match Criteria” (ERMC): means an exact match between a reported outflow positioning plan of a particular location by a shipping company and a reported inflow positioning plan of that same location by another shipping company, excluding the execution time and quantity type match.

“Exact Execution-time Match Criteria” (EEMC): means a match between a reported outflow positioning plan of a particular location by a shipping company where the referred execution time is within a specific period of time greater or lower than the execution time of a reported inflow positioning plan. The specific period of time is decided by the system administrator, and may for example be 2 days greater or lower than the execution time of the matched positioning plan. Time periods greater or lesser than 2 days are contemplated in further embodiments.

“Exact Quantity Match Criteria” (EQMC): means a match between a reported outflow repositioning plan and a reported inflow repositioning plan of a particular location, where the available quantity of equipment to be moved under the outflow plan is equal to the inflow plan, or greater or lesser than the inflow plan by a predetermined amount. The matching quantity of equipment is the quantity representing the less amount of equipment.

“Customer Priority Level” (CPL): means a number assigned by the Match Maker Engine to a potential match between an inflow and outflow equipment positioning plan pursuant to a particular matching rule.

In one embodiment, the match maker engine 22 processes the reported equipment repositioning plan information in two phases. In Phase 1, the match maker engine duplicates the equipment positioning plan information (thereby creating a second copy of the plan) and assigns a location name, equal to departure location name, to the first plan and it becomes an “outflow plan.” In Phase 1, the match maker engine further assigns another location, equal to destination location name, to the second (duplicated) plan and it becomes an “inflow plan.” In Phase 2, the match maker engine 22 automatically attempts to assign outflow plans to inflow plans using the three-way match criteria satisfying ERMC, EEMC and EQMC among different shipping companies. If all outflow and inflow plans are met, processing stops and system sends the recommendation to users for equipment positioning cancellation or correction. That is, the system has identified a plan which accomplishes the required transport without one or both shippers having to use their own resources as originally planned. Thus one or both shippers may then cancel or correct their relocation plans in accordance with the recommendation of the present system.

If all outflow and/or inflow plans are not met, the remaining unassigned outflow and inflows plans plus the recommended but refused plans wait for the next planning horizon and the Phase 2 is run again.

It is possible that in Phase 2, the Match Maker Engine 22 outputs more than one matching that satisfies the required matching criteria/rules. In such cases, the Match Maker Engine will use the Customer Priority Level (CPL) to determine the most preferred order in time/date to send/output the found matches to each customer. In one embodiment, the Match Maker Engine will select the set of matches that have the highest CPL of all other variable matches.

The Match Maker Engine will compute a total CPL according to specific requirement of the system administrator. In the present embodiment, Match Maker Engine uses the CPLs to account for several criteria including but without limitation to the actual percentage of confirmation-matches volume; grade of urgency for getting a match.

With respect to the percentage of confirmation-matches volume, the higher CPL may be assigned to the client with the highest percentage of confirmed equipment move cancellation. The percentage may be calculated by taking the number of matches (i.e. containers move cancellation) by a client during an agreed period of time (i.e. a month) divided by the total equipment fleet (i.e. container fleet) of mentioned client (i.e. a shipping line).

With respect to the grade of urgency for getting a match: A higher CPL will be assigned to the client who accepts to pay the highest fee per found match; mentioned fee will be settled according to two proposed options:

Previously agreed pricing plans. A pricing plan could be 10%, 20%, 30%, 40%, 50%, etc more than the basic pricing plan.

According to a bidding process. This bidding process is previously agreed by the user (i.e. shipping company) and the service provider.

The following is an example of a created message of a recommended equipment reposition cancellation or correction plan:

A message to (shipping company#1) from the service provider.

Cancel/Correct (quantity) ( Equipment type )(Equipment sub-type) at (location).

Once recommended cancellation or correction to equipment repositioning plan has been determined by the match maker engine 22 and reported back to the interested shipping companies via the user interface 16 (or other communication means, such as email, text message, fax, letter, etc), the user interface 16 (or other means) enables the shipping companies to accept the proposed cancellation or correction to the plans. The transaction management engine 24 administers the transaction by, for example, enabling the system administrator and the various shipping companies to track the amount correction or cancellation through the user interface 16 and triggering necessary events related to the equipment management process, such as fee collection, equipment return notices, overdue notices, insurance claims, and the condition of returned equipment.

The report generator 26 is used to develop canned and customized reports to capture information of equipment repositioning confirmation and cancellation proposal equipment by type, by execution time, by location, etc. to support the function of managing the equipment and vehicle utilization service provided by the system of the present invention.

Overall operation of the server 10 is coordinated by a management system 20 as shown. Preferably, the management system is capable of providing up-to-the second searches for matching equipment positioning plans with real-time notification of progress. This capability is useful, for example, in the event of last minute change to inflow and outflow plans caused, for example by an increase of required equipment to comply with a amended equipment repositioning plan, or by an unexpected delay in equipment availability status.

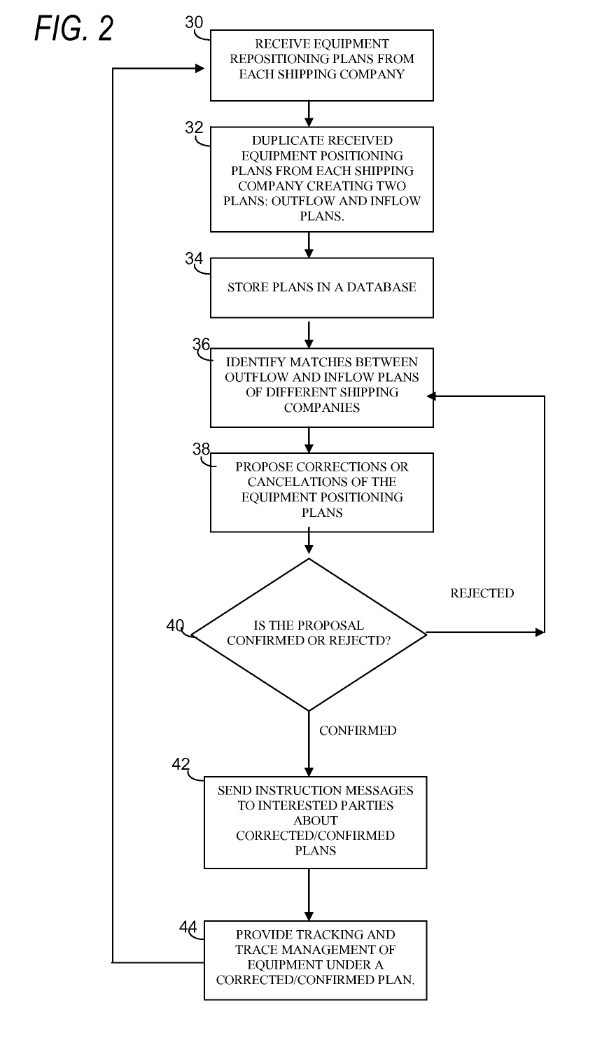

FIG. 2 is a flow diagram illustrating a process according to embodiments of the present invention that is performed automatically by the system of FIG. 1. As shown at step 30, the system receives reports of equipment repositioning plans or equipment use forecast from each shipping company for the next planning horizon. At step 32, the received reports are automatically duplicated, creating a second plan for each equipment repositioning plan, the first/original plan becomes the outflow plan and the second plan becomes the inflow plan. A location name equal to departure location is assigned to the “outflow plan” and a location name equal to the destination location is assigned to the “inflow plan”. At step 34, those plans among various shipping companies are stored in the database 18. An example of an outflow plan submitted by a shipping company is:

shipping company: “Carrier X” (ID: 001)

Departure Location: Singapore (equal to Outflow location)

Equipment: 40′Reefer

Quantity of equipment to be moved: 180

Execution time: Jan. 10, 2010

Vehicle name: M.V. Panama Star 001

An example of an Inflow plan submitted by a shipping company is:

shipping company: “Carrier X” (ID: 001)

Destination Location: Rotterdam (equal to Inflow location)

Equipment: 40′Reefer

Quantity of equipment to be moved: 180

Execution time: Jan. 10, 2010

Vehicle name: M.V. Panama Star 001

At step 36, matches between reported outflow and inflow plans of the different shipping companies are automatically identified. The program compares inflow plans with outflow plans using several filters to fulfill a match criteria: firstly it looks for outflow plans of a specific location and matches them with inflow plans with the same specific location—as indicated, this filter is called ERMC (Exact Repositioning-plan Match Criteria). Once first filter has been run, a group of surviving outflow and inflow plans is once again filtered. That second filter is run by the program looking for the execution time of an outflow plan to be matched with the inflow plans with the same or closer execution time. As indicated, this second filter is called EEMC (Exact Execution-time Match Criteria). Finally a third filter is run by the program looking for the quantity of an outflow plan and matching them with the quantity of inflow plans until complete the total quantity of the referred outflow plan.

It could be that more than one inflow plan satisfies the same location, execution time, and quantity for an outflow plan. In that case, the program orders those matches using a priority order manually assigned by the system administrator to each user. This is the CPL order referred to above. In one embodiment, step 36 is performed according to the three-way match criteria described above.

Next, at step 38, corrections or cancellation equipment repositioning plans are proposed. The proposal is the resulting match after an outflow plan has been compared against the inflow plans of other shipping companies. An example of a proposal or match message is: “System has found a match to satisfy your outflow (or inflow) plan. We recommend you to cancel or correct your plan and accept to use the equipment resources of other shipping company”. Those proposals or matches are sent to the interested parties who may then confirm or refuse the proposed amendment at step 40. The proposals are generated and reported to the shipping companies via the user interface, or via other communication means (email, text message, fax, letter, etc).

The shipping companies use the user interface to accept or refuse the proposals by clicking on the user interface (accept or reject button). If the proposal is refused, the match is dissolved and both plans (outflow and inflow) return to step 36 to wait for next planning horizon and run again looking for match according to the three-way match criteria. In other words, once a match (proposal) is refused by a shipping company, the system takes the inflow and outflows plans which were matched, un-matches (releases) those plans, and runs the three-way match criteria filtering process again, comparing the outflow plan against new entered inflow plans. For each pair of shipping companies that accept/confirm cancellation or correction of equipment repositioning plan proposed by the system, at step 42, the system sends instruction message to the interested parties via the user interface, and/or via other communication means (email, text message, fax, letter, etc). An example of an instruction message is: “Thanks for accepting this match. Following are the counterpart details: IN(or OUT) FLOW plan: Receipt Location: Singapore/Quantity: 180×40′ Reefer/Equipment Receiver: Carrier X/Phone: 555-5555/e-mail: someone@e-mail.com” and then provides, in step 44, the equipment repositioning plan management service described above. This process is then repeated for the next planning horizon.

The system and method of the present invention, including, for example, the functionality of any or all of the users interface 16, the data base 18, the match maker engine 22, the transaction management engine 24, the report generator 26 and the system management 20 may be embodied in the form of program code (i.e., instructions). The program code may be stored on a compute readable medium, such as floppy diskette, CD-ROM, DVD-ROM, DVD-RAM, hard disk drive or any other machine-readable storage medium. When the problem code is loaded into and executed by a machine, such as a computer, the machine becomes an apparatus for practicing the invention. The system and method of the present invention may also be embodied in the form of program code that is transmitted over some transmission medium, such as electrical wiring or cabling through fiber optics, over a network including the Internet or an intranet, or via any other form of transmission. When implemented on a general-purpose processor, the program code is run by the processor and the product is the unique apparatus that operates analogously to specific logic circuits. The program code might be implemented in a high level procedural or object-oriented programming language, such as, for example, C, C++, or Java. Alternatively, the program code may be implemented in assembly or machine language. In any cases, the languages may be a compiled or an interpreted language.

Microsoft and the Microsoft Internet Explorer logo are registered trademarks of Microsoft Corporation. Netscape and Netscape Navigator are registered trademarks of Netscape Communications Corporation. Java is a trademark of Sun Microsystems, Inc. Oracle is a registered trademark of Oracle Corporation.

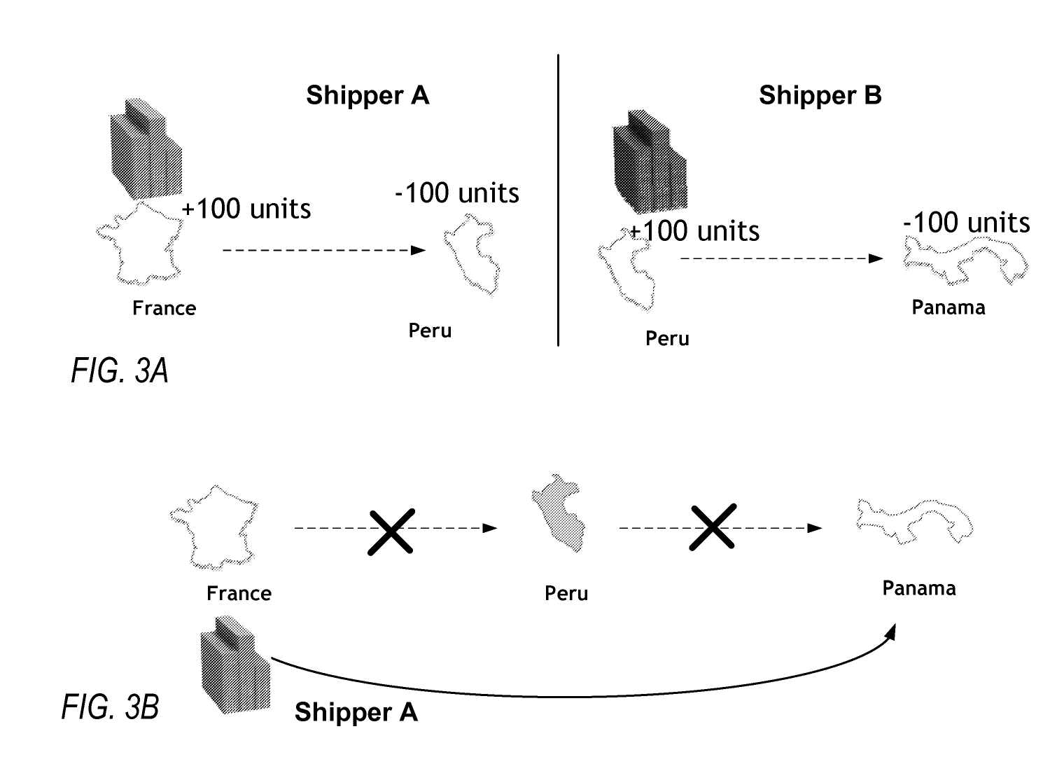

A simple example of the operation of the present invention will now be explained to FIGS. 3A and 3B. In the example of FIG. 3A, shipper A has a surplus of 100 containers in France and requires 100 more containers in Peru. Shipper A therefore has a repositioning plan to send 100 containers from France to Peru. On the other hand, Shipper B has a surplus of 100 containers in Peru and requires 100 more containers in Panama. Shipper B therefore has a repositioning plan to send 100 containers from Peru to Panama.

Referring now to FIG. 3B, if Shippers A and B both make use of the system of the present invention, they submit their repositioning plans to server 10. The server 10 then generates inflow and outflow plans for each shipper as described above. The system then identifies a match between the inflow plan of shipper A and the outflow plan of shipper B. The system then contacts both shippers, alerting them to the match. Shippers A and B accept the recommendation and modify/cancel their repositioning plans accordingly. Shipper A now transports 100 containers from France to Panama for use by Shipper B in Panama. In Peru, shipper B provides 100 containers to Shipper A for use by Shipper A. In this way, the system maximizes the transport efficiencies of both Shippers A and B, and reduces the operating expenses of both Shippers A and B.

In the foregoing example, the present invention allowed two shipping companies to take advantage of complementary inflow and outflow repositioning plans. In further embodiments, multiple pairs of shipping companies may find complementary inflow and outflow repositioning plans. Moreover, instead of identifying a pair of companies having complimentary repositioning plans, the present invention may identify three or more companies which, all together, have complimentary repositioning plans.

As the foregoing illustrates, the present invention is directed to a system, method, and computer program product to maximize equipment and consequently vehicle space utilization by reducing the amount of equipment repositioning plans and reducing vehicles rotation between a plurality of shipping companies. The present invention can be used to provide equipment positioning plan information to the shipping companies. It is understood that changes may be made to the embodiments described above without departing from the broad inventive concepts thereof.

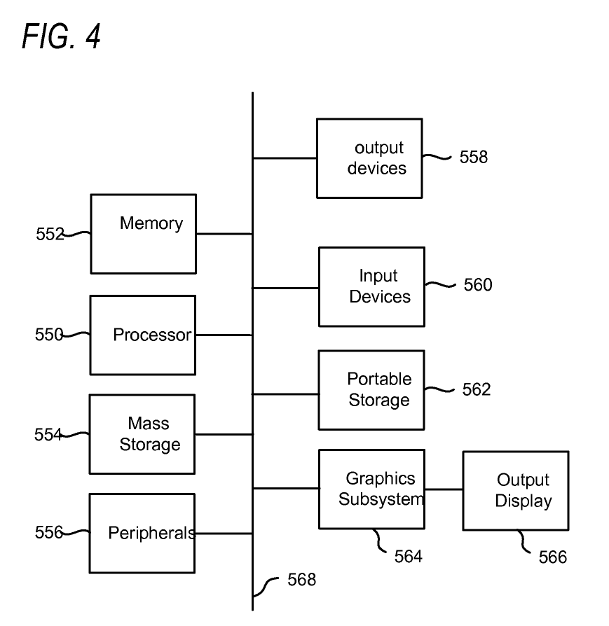

FIG. 4 illustrates a high level block diagram of a computer system which can be used to perform any of the processes described herein and which can be used to implement any of the computing devices (e.g., server 10 or clients 12a-c) depicted in FIG. 1. The computer system of FIG. 4 includes one or more processors 550 and main memory 552. Main memory 552 stores, in part, instructions and data for programming processor unit 550 to perform the processes described herein. If the system of the present invention is wholly or partially implemented in software, main memory 552 can store the executable code when in operation. The system of FIG. 4 further includes a mass storage device 554, peripheral device(s) 556, user input device(s) 560, output devices 558, portable storage medium drive(s) 562, a graphics subsystem 564 FIG. 4 are depicted as being connected via a single bus 568. However, the components may be connected through one or more data transport means. For example, processor unit 550 and main memory 552 may be connected via a local microprocessor bus, and the mass storage device 554, peripheral device(s) 556, portable storage medium drive(s) 562, and graphics subsystem 64 may be connected via one or more input/output (I/O) buses. Mass storage device 554, which may be implemented with a magnetic disk drive or an optical disk drive, is a non-volatile storage device for storing data and instructions for use by processor unit 550. In one embodiment, mass storage device 554 stores the system software for implementing the present invention for purposes of loading to main memory 552.

Portable storage medium drive 562 operates in conjunction with a portable non-volatile storage medium, such as a floppy disk, to input and output data and code to and from the computer system of FIG. 4. In one embodiment, the system software for implementing the present invention is stored on such a portable medium, and is input to the computer system via the portable storage medium drive 562. Peripheral device(s) 556 may include any type of computer support device, such as an input/output (I/O) interface, to add additional functionality to the computer system. For example, peripheral device(s) 556 may include a network interface for connecting the computer system to a network, a modem, a router, etc.

User input device(s) 560 provides a portion of a user interface. User input device(s) 560 may include an alpha-numeric keypad for inputting alpha-numeric and other information, or a pointing device, such as a mouse, a trackball, stylus, or cursor direction keys. In order to display textual and graphical information, the computer system of FIG. 3 includes graphics subsystem 564 and output display 566. Output display 566 may include a cathode ray tube (CRT) display, liquid crystal display (LCD) or other suitable display device. Graphics subsystem 564 receives textual and graphical information, and processes the information for output to display 566. Additionally, the system of FIG. 3 includes output devices 558. Examples of suitable output devices include speakers, printers, network interfaces, monitors, etc.

The components contained in the computer system of FIG. 4 are those typically found in computer systems suitable for use with the present invention, and are intended to represent a broad category of such computer components that are well known in the art. Thus, the computer system of FIG. 4 can be a personal computer, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application, to thereby enable others skilled in the art to best utilize the invention in various embodiments and with various modifications as are suited to the particular use contemplated. It is intended that the scope of the invention be defined by the claims appended hereto.

What is claimed is:

1. A machine implemented method for maximizing equipment and vehicle utilization by reducing the amount of equipment positioning plans among a plurality of shipping companies, comprising the steps of:
receiving a report of equipment repositioning plans or equipment use forecast from each shipping company;
automatically duplicating an equipment repositioning plan to create a second plan assigning the departure location to the original plan and the destination location to the second/duplicated plan as their execution location;
automatically matching equipment pairs of reported equipment repositioning plans from a first shipping company and created duplicate plans reported at the same specific location from a second shipping company from the received report of equipment positioning plan and duplicate plans; and
automatically proposing the selected equipment pair to the first and second shipping companies for a cancellation or correction transaction of matched equipment positioning plans pair between them, wherein the proposing includes creating and reporting a proposal to the first and second shipping companies.

2. The method recited in claim 1, wherein:
said step of receiving a report of equipment repositioning plan from each shipping company comprises receiving the following information concerning an equipment repositioning plan of a particular location: (i) an indication of the equipment size, (ii) an indication of the equipment type (iii) an indication of equipment sub-type (iv) an indication of the quantity of the equipment going to be repositioned, (v) an indication of the place where the plan will be executed or where the positioning plan will depart (vi) an indication of the departure date or date when plan will be executed, (vii) an indication of the destination location, and (viii) an indication of the vehicle name or identification where the equipment will be transported.

3. The method recited in claim 1, wherein said step of creating a duplicate plan for the receiving a report of equipment inflow and outflow positioning plans from each shipping companies comprises duplication of following information concerning an equipment repositioning plan of a particular location: (i) an indication of the equipment size, (ii) an indication of the equipment type (iii) an indication of equipment sub-type (iv) an indication of the quantity of the equipment going to be repositioned, (v) an indication of the departure date or date when plan will be executed, (vi) an indication of the destination location, and (vii) an indication of the vehicle name or identification where the equipment will be transported.

4. The method recited in claim 1, wherein said proposal for a cancellation or correction transaction of positioning plans between the first and second shipping companies comprises a proposed cancellation or correction of loading and discharging of equipment of the equipment repositioning plans from the first shipping company and the second shipping company.

5. The method recited in claim 4, further comprising the steps of:
receiving confirmation of the proposed cancellation or correction of equipment repositioning plan from the first and second shipping companies; and
providing equipment management services to the first and second carriers to facilitate the amount control of equipment positioning plan cancelled or corrected between them.

6. The method recited in claim 5, further comprising the step of charging the first and second shipping company a fee based on the receiving of a proposed cancellation or correction transaction.

7. The method recited in claim 1, further comprising requesting payment from each of the shipping companies for performing said receiving, matching, and cancellation/correction proposing steps for them.

8. The method recited in claim 1, wherein the step of matching comprises: matching, based on a three-way matching criterion, the reported equipment repositioning plan from the first shipping company with the created/duplicate equipment repositioning plan of the second shipping company.

9. One or more processor readable storage devices having processor readable code embodied on said processor readable storage devices, said processor readable code for programming one or more processors to perform a method comprising the steps of:
receiving a report of equipment repositioning plans or equipment use forecast from each shipping company;
duplicating equipment repositioning plan creating a second plan assigning the departure location to the original plan and the destination location to the second/duplicated plan as their execution location;
matching equipment pairs of reported equipment repositioning plans from a first shipping company and created duplicate plans reported at the same specific location from a second shipping company from the received report of equipment positioning plan and duplicate plans; and
proposing the selected equipment pair to the first and second shipping companies for a cancellation or correction transaction of matched equipment positioning plans pair between them.

10. The one or more processor readable storage devices recited in claim 9, said matching step comprising the steps of identifying first and second equipment pairs arriving at, and departing from, the same location within a predetermined time of each other, and having respective quantities within a predetermined amount of each other.

11. The one or more processor readable storage devices recited in claim 9, the method further comprising the step of receiving feedback as to whether the first and second shipping companies accept the proposed selected equipment pair.

12. An apparatus, comprising:
a communication interface such as a network card or modem;
one or more storage devices; and
one or more processors in communication with said one or more storage devices and said communication interface, said one or more processors receive a report of equipment repositioning plans or equipment use forecast from each shipping company, duplicate equipment repositioning plan creating a second plan assigning the departure location to the original plan and the destination location to the second/duplicated plan as their execution location, match equipment pairs of reported equipment repositioning plans from a first shipping company and created duplicate plans reported at the same specific location from a second shipping company from the received report of equipment positioning plan and duplicate plans and propose the selected equipment pair to the first and second shipping companies for a cancellation or correction transaction of matched equipment positioning plans pair between them.

13. The apparatus of claim 12, wherein the one or more processors identify first and second plan pairs arriving at, and departing from, the same location within a predetermined time of each other, and having respective quantities within a predetermined amount of each other.

14. A method of determining repositioning plans for a plurality of shippers, the method comprising the steps of:
receiving a report of equipment repositioning plans from the plurality of shippers;
duplicating an equipment repositioning plan for each shipping company to create a first plan from the original equipment repositioning plan, and a second plan from the duplicated plan;
comparing the first plan of a first shipper to the second plans of other shippers; and
transforming the equipment repositioning plans for the first and at least one additional shipper by identifying a second plan of the at least one additional shipper matching the first plan of the first shipper.

15. The method recited in claim 14, wherein said step of comparing includes the step of identifying first and second plan pairs arriving at, and departing from, the same location.

16. The method recited in claim 15, wherein said step of comparing further includes the step of identifying first and second plan pairs arriving at, and departing from, the same location within a predetermined time of each other.

17. The method recited in claim 16, wherein said step of comparing further includes the step of identifying first and second plan pairs arriving at, and departing from, the same location within a predetermined time of each other, and having respective quantities within a predetermined amount of each other.

18. The method of claim 14, further comprising the steps of:
receiving confirmation of the transformation of the equipment repositioning plans from the first and second shippers; and
providing equipment management services to the first and second shippers to facilitate the amount control of equipment positioning plan cancelled or corrected between them.

19. The method of claim 14, wherein said duplication step comprises duplication of following information concerning an equipment repositioning plan of a particular location: (i) an indication of the equipment size, (ii) an indication of the equipment type (iii) an indication of equipment sub-type (iv) an indication of the quantity of the equipment going to be repositioned, (v) an indication of the departure date or date when plan will be executed, (vi) an indication of the destination location, and (vii) an indication of the vehicle name or identification where the equipment will be transported.

20. The method of claim 14, wherein the one or more additional shippers comprise more than one additional shipper.
